(19) United States
(12) Patent Application Publication
(10) Pub. No.: US 2014/0017369 A1
(43) Pub. Date: Jan. 16, 2014

(54) SOUP COMPACTS

(71) Applicants: Valérie Soquet, Villeurbanne (FR); Marie Rastello-De Boisseson, Le Bouscat (FR)

(72) Inventors: Valérie Soquet, Villeurbanne (FR); Marie Rastello-De Boisseson, Le Bouscat (FR)

(73) Assignee: EUROTAB, Saint-just-saint-rambert (FR)

(21) Appl. No.: 13/984,653

(22) PCT Filed: Feb. 14, 2012
(86) PCT No.: PCT/FR12/50322

§ 371 Date: Sep. 24, 2013

(30) Foreign Application Priority Data
Feb. 14, 2011 (FR) 1151197

(51) Int. Cl. A23L 1/40

(52) U.S. Cl. CPC A23L 1/40
USPC 426/285; 426/589

(57) ABSTRACT

Soup compacts and a method of manufacturing said compacts. The soup compact of the invention contains 70% to 100% by weight of a soup powder and 0 to 30% by weight of pelletizing additives, the compact being in the form of a solid unit of homogeneous composition that presents a crust of thickness lying in the range 10 μm to 1 mm. Optionally, the compact presents at least one morsel on its surface.

The present invention relates to soup compacts and to the method of manufacturing said compacts.

The term “soup compact” means a soup powder that is compacted or compressed. Such soup compacts are generally in the form of lozenges, pellets, or tablets.

A soup compact combines the advantages of dehydrated or lyophilized soup in terms of shelf life and stability, with the advantages of an easy-to-handle solid form.

Application WO 2007/104326 describes a soup compact comprising a core-and-crust structure that is obtained by compressing a soup composition by means of rollers, then coating it with an appropriate edible solution that is suitable for protecting the compressed composition.

In order to provide cohesion and mechanical strength to the soup compact, the composition of the coating is essentially made up of additives such as isomalt and gum Arabic, the coating possibly representing up to 50% by weight of the total weight of the compact. Such cohesion is also generally provided by using suitable packaging.

Furthermore, the use of rollers puts a considerable limit on the potential shapes for the compact.

Application JP 2004 049221 describes a method of preparing a Japanese soup pellet of the essentially-protein bouillon type.

The present invention thus relates to a soup compact that seeks to remedy the above-mentioned drawbacks.

More particularly, the invention provides a soup compact containing 70% to 100% by weight of a soup powder and 0 to 30% by weight of technical additive(s), said compact being in the form of a solid unit of homogeneous composition that presents a crust of thickness lying in the range 10 micrometers (μm) to 1 mm, preferably in the range 20 μm to 500 μm, the percentages by weight being given relative to the total weight of the compact.

Throughout the application and unless explicitly specified to the contrary, all of the ranges mentioned should be understood as including the limits of the range.

The term “soup powder” means a dehydrated or lyophilized soup in powder form, and more particularly soup powder containing at least 20% plant matter. Such soup powders are commercially available. It is also possible to prepare such soup powders from various powder ingredients (such as powdered vegetables and/or seasoning powder) that are mixed together. Preparing such soups generally comprises a step of putting the soup powder into solution in hot water (instant soups) for the purpose of reconstituting the soup, possibly followed by a cooking step (soups for cooking) with a view to thickening the soup.

The term “technical additive” means an additive that makes it possible to improve cohesion (pelletizing additive), or on the contrary an additive that makes it easier to crumble the pellet (crumbling additive). More particularly, the additives are selected from sorbitol, maltitol, mannitol, guar gum, xanthan gum, acacia gum, gum Arabic, agar agar, inulin, and oligofructose, with the exception of salt. More particularly, the technical additive is sorbitol.

It is also possible to add a dietary fiber supplement. The fibers have high absorption and swelling capacity in water. By way of example, the dietary fibers may be wheat fibers, carrot fibers, apple fibers, oat fibers, orange fibers, lemon fibers, acacia fibers, cellulose fibers. Preferably, carrot fibers are used.

The term “homogeneous composition” means that the compact has the same composition throughout. In particular, the crust does not have a specific composition. The crust results merely from the creation of bridges on the surface of the compact as a result of solubilization, following the soluble active agents of the composition drying on the surface. The crust is thus very thin, does not spoil the taste, and provides the compact with part of the strength it needs for it to be easily handled and transported. Preferably, the thickness of the crust lies in the range 20 μm to 500 μm, preferably 50 μm to 400 μm, and more preferably 70 μm to 200 μm. The term “crust thickness” means an average thickness in so far as the crust formed by the method of the invention may present variations in thickness.

Advantageously, the compact of the invention contains soup powder having a salt content that is not greater than 20% by weight relative to the weight of the soup powder, preferably not greater than 10%. A known means for providing cohesion to a compact is to increase its salt content. Unfortunately, such an increase is damaging to health.

The compact may, in particular, be prepared from a soup powder having the following composition:
0 to 20% of salt, preferably 0 to 10%;
0 to 25% of lipids, preferably 0 to 10%;
10% to 80% of carbohydrates; and
20% to 100% of plant matter, preferably 25% to 90%;

these percentages by weight being given relative to the total weight of the soup powder.

This composition presents lipid and salt contents that are particularly low. These two ingredients are often used to provide cohesion of the compact. Nevertheless, the compact of the invention presents cohesion and strength that are sufficient to make it possible to achieve lipid and salt levels that are particularly low, even though a limited amount of additive is included in order to preserve the taste.

The term “plant matter” is used more particularly to mean:
vegetables such as leeks, potatoes, peas, carrots, beans, courgettes, turnips;
fruits such as tomatoes, lemons; and
spices and herbs such as nutmeg, curry, parsley, chives, onion, garlic.

The powder may also include other ingredients such as proteins, flavor enhancers, food colorants, and any other ingredient usually incorporated in soup powders.

The soup compact of the invention has a density lying in the range 0.7 grams per cubic centimeter (g/cm³) to 1.5 g/cm³, more preferably in the range 0.8 g/cm³ to 1.2 g/cm³.

As a result of the method used for obtaining it, and more particularly as a result of its crust, the compact of the invention is extremely strong, while presenting great capacity to crumble on coming into contact with hot water.

In particular, the strength of the compact may be characterized by its diametral strength and by its friability.

The diametral strength of the soup compacts of the invention is measured by applying a force diametrally until the compact ruptures. A Dr Schleuniger hardness tester is used to measure hardness. The rupture force is converted into pressure so as to be unaffected by the contact area on which the force is exerted. For a cylindrical lozenge for example, the pressure on rupture in megapascals (MPa) is equal to twice the rupture force in newtons (N) divided by the area in square millimeters (mm²) of the ring under stress of the cylinder. The diametral strength, expressed in units of stress, lies in the range 0.01 MPa to 0.4 MPa, preferably in the range 0.02 MPa to 0.3 MPa, and more preferably in the range 0.03 MPa to 0.25 MPa.

Friability is a measure of the loss of powder from a soup compact after it has been dropped in accordance with predetermined conditions. The friability of the soup compacts of the invention may be measured by means of a friability tester of the SOTAX F2 type that is provided with a friability drum. Depending on the size of the compact, 2 to 5 soup compacts are inserted into the drum that revolves at a speed of 20 revolutions per minute (rpm) for 15 seconds (s) (i.e. 5 revolutions). The compacts are weighed before the test and at the end of the test, the compacts being dusted off by means of a brush prior to weighing. Friability is calculated as a percentage by using the following formula:

Friability(%)=100×(initial weight of the compacts−weight of the compacts after the test)/initial weight of the compacts. At the end of the test, the soup compacts should not be broken.

Advantageously, the soup compacts of the invention present a friability percentage that is not greater than 10%, preferably not greater than 5%, still more preferably not greater than 3%.

The compact of the invention presents a crumbling time in water at 80° C. that is not greater than 2 minutes (min), preferably not greater than 1 min, more preferably not greater than 30 s.

Crumbling of the soup compact in fact comprises two distinct phenomena:
dissolving the soup powder elements that can be dissolved in water (which powder might include additives); and
dispersing the insoluble elements.

The soup powder of the invention incorporates 0 to 30% by weight of technical additive(s) necessary for preparing the compact. Preferably, 0 to 15% by weight of technical additive(s) is incorporated in the soup, and still more preferably 0 to 5% by weight of technical additive(s).

In the meaning of the invention, technical additives do not include additives that are already present in the powder. By way of example, mention may be made of maltodextrin, lactose, sugar, dextrose, glucose, lecithin, citric acid, starch, dietary fibers, flavor enhancers, flavorings, fats, salt, and/or milk proteins. Depending on the recipe, these ingredients are optionally present in the composition (and their quantities may be adjusted) in order to act on flavor, texture, or preservation.

Advantageously, pelletizing additives are selected from the group made up of sorbitol, mannitol, maltitol, guar gum, xanthan gum, acacia gum, and/or gum Arabic.

Advantageously, crumbling additives are selected from the group made up of sorbitol, guar gum, xanthan gum, acacia gum, gum Arabic, and/or agar agar.

In addition, it may be advantageous to introduce solid morsels into the composition of the soup such as croutons or even real fragments of vegetables. The inventors have observed that introducing morsels into the powder mixture to be compacted poses problems with failures in pelletizing and with non-uniformities in the mixture, or even with the morsels breaking. More precisely, the addition of morsels creates problems of cracking, breaking, and over-compacted zones in the pellet.

The invention thus also relates to a soup compact presenting at least one morsel on the surface of the solid unit.

The term “morsel” means a particle having a size that is at least twice the average size of a powder particle used for preparing the compact. Preferably, the size of a morsel is five times larger, more preferably still ten times larger than the average size of a powder particle.

The average size of a particle of powder generally lies in the range 60 μm to 700 μm, while the average size of a morsel generally lies in the range 800 μm to 1 centimeter (cm). The term “average size of a particle” means the average size of its greatest dimension.

Preferably, the compact presents a plurality of morsels that are distributed on its surface.

The distribution of the morsels on the surface of the compact may be partial or complete, i.e. the morsels may cover all of the surface of the compact or only a fraction. By way of example, a compact in tablet form has two faces. Coating may be performed on a single face or on all of the tablet. In addition, the morsels in the coating may be distributed uniformly or non-uniformly on the compact.

In order to give a few non-exhaustive examples of morsels that could be used, mention may be made of: croutons; morsels of dehydrated vegetables including starchy foods such as peas or tapioca; pasta; cereals such as wheat or corn; vermicelli; morsels of meat; seeds; dry fruit; fine herbs, morsels of cheese; or mixtures thereof.

The soup compacts of the invention, possibly presenting a morsel on the surface, can be of various shapes, generally having a weight lying in the range 5 grams (g) to 45 g.

The invention also relates to the method of manufacturing the soup compact of the invention.

The method of manufacture comprises the steps consisting in:

a) compressing the soup powder, optionally containing technical additives, while holding a constant volume for time that is sufficient for the holding force to diminish by at least 10% so as to obtain a solid unit;

b) moistening the solid unit; then

c) drying the solid unit.

Step a) of the method corresponds to a step of compression (or compaction) at constant volume. The step of compression at constant volume comprises various sub-steps consisting in:

i) placing an initial volume of soup powder in a confined space, the powder optionally containing additive;

ii) compressing said soup powder that optionally contains additive until it reaches a compaction volume that is not greater than the determined volume;

iii) holding said soup powder that optionally contains additive at said compaction volume until the holding force has diminished by at least 10%;

iv) relaxing the compaction volume and obtaining the solid unit of determined volume.

The term “initial volume” of the powder means the volume of the relaxed powder before compression, such as it is placed in the confined space. Then, the powder is compressed until it reaches a compaction volume. The compaction volume is less than the initial volume of the powder. Preferably, the compaction volume lies in the range 20% to 95% of the initial volume of the powder, and preferably in the range 30% to 75% of the initial volume of the powder. This compaction should be controlled so as to obtain a solid unit without defects: this is achieved by adjusting the time for which constant volume is held.

The term “determined volume” of the solid unit means the final volume of the solid unit, and thus the volume that it is desired to obtain. When the powder presents a certain degree of springiness, the solid unit may expand during relaxation of the compaction volume.

In a preferred embodiment, in step a), the sub-step ii) may be preceded by a sub-step of pre-compressing to a compaction volume lying between the initial volume and the determined volume, at a force not greater than the compression force applied in sub-step ii). This sub-step of pre-compression is followed by a relaxation of the pressure before performing compression.

Advantageously, the time required for compression in step ii) lies in the range 1 millisecond (ms) to 3000 ms, and more advantageously in the range 10 ms to 1500 ms, and/or the compression speed lies in the range 1 millimeter/second (mm/s) to 200 mm/s, preferably in the range 10 mm/s to 100 mm/s, and more preferably in the range 20 mm/s to 80 mm/s.

During sub-step iii), the compaction volume is held constant by keeping the bottom and top punches in a stationary position. Holding the compaction volume corresponds to this stationary position of the bottom and top punches. Consequently, the force measured during step iii) and applied to the solid unit diminishes over time, and the expansion of the solid unit during relaxation of the compaction volume is controlled.

Advantageously, the time the constant volume is held lies in the range 0.1 s to 5 s, preferably in the range 0.2 s to 4 s, more preferably in the range 0.3 s to 3.5 s, and the holding force diminishes by a value lying in the range 10% to 60%.

The compression step produces a solid unit of compressed powder. However, the unit does not present sufficient mechanical strength for it to be packaged, transported with a view to being sold, and finally handled by the consumer. However, the inventors have shown that the step of compression at constant volume does make it possible to obtain a compact of cohesion that is sufficient for it to be capable of being subjected to the following steps of the method without being degraded.

Step b) of the method of the invention seeks to moisten the solid unit so as to dissolve the soluble compounds on the surface so that after drying there is a change in the physical properties of the compounds (e.g. a transition from an amorphous state to a crystalline state) thereby increasing the hardness of the soup compact. However, the added water must occupy only the surface of the compact without penetrating deeply into the compact, so that, after drying, a thin protective crust is formed, while not degrading the crumbling properties of the final soup compact.

The quantity of water added per unit area advantageously lies in the range 0.2 mg/cm² to 10 mg/cm², preferably in the range 0.5 mg/cm² to 8 mg/cm², and more preferably in the range 1 mg/cm² to 6 mg/cm².

Moistening may be achieved by using various technologies such as a steam tunnel, a chamber having controlled temperature and moisture, and spraying. In a preferred embodiment, moistening is achieved by spraying a controlled quantity of water in uniform manner over the entire surface of the pellet.

Spraying also makes it possible to perform the moistening step in a very short time, thereby limiting the degree to which the soluble active agents dissolve and the depth to which the moisture penetrates into the solid unit, and reduces the risks of bacteria developing. Furthermore, spraying also makes it possible to limit and control the quantity of water completely, to distribute it in uniform manner, and to make the drying step easier.

The time for moistening by spraying advantageously lies in the range 50 ms to 500 ms as a function of the rates of production used, and preferably in the range 100 ms to 300 ms.

Water may be sprayed at a temperature lying in the range 5° C. to 25° C., preferably in the range 10° C. to 15° C., but also in the range 75° C. to 95° C., preferably in the range 80° C. to 90° C., so as to reduce the risks of bacteria developing.

The purpose of moistening the surface of the solid unit is also to initiate rehydration of the ingredients such as vegetables, consequently imparting more vibrant and natural colors to the compact.

Step c) of the method seeks to dry the moistened solid unit in such a manner as to return it to its initial moisture content before moistening, and more particularly to the moisture content of the soup powder that optionally contains additive(s). More precisely, the drying step makes it possible to re-establish the initial moisture content of the solid unit with an accuracy of plus or minus 1%, preferably 0.5%, more preferably 0.2%. The initial moisture content of the solid unit is approximately the moisture content of the soup powder. The moisture content of the soup powder is generally not greater than 15%, and preferably not greater than 10%, while the moisture content of additives, if any, is frequently not greater than 10%. Either way, the added quantities of additives do not change the moisture content of the soup powder significantly. After step a) of the method of the invention, the moisture content of the solid unit is approximately the moisture content of the soup powder. During step b) of the method of the invention, the percentage of water on the surface of the unit increases, but in the core of the solid unit the quantity of water remains unchanged. Consequently, step c) of the method of the invention should be performed immediately after step b) and in the shortest possible time so as to prevent the water that is applied to the surface of the compact from penetrating into the core of the compact.

Drying may be performed using conventional drying technologies such as hot-air ovens, infra-red (IR) rays, microwave drying.

As mentioned above, using spraying to perform the moistening step makes it possible to use drying times that are very short. Advantageously, the drying time is not greater than 1 min, preferably not greater than 30 s, more preferably not greater than 20 s.

In a preferred embodiment, step c) is performed by IR, preferably by means of an IR tunnel. It is possible to use IR as a result of the water being sprayed during the second step, which spraying makes it possible to dispense a quantity of water that is limited and that is distributed in uniform manner. IR essentially dries to a small depth. Thus, in a very short drying time, all of the water added to the surface during the second step is eliminated, the compact returns to its initial weight before moistening, and a thin and strong crust is created.

The invention also covers soup compacts that may be obtained by the method of the invention.

The invention also proposes a method of manufacturing a soup compact presenting at least one morsel on the surface of the solid unit.

Advantageously, the method comprises the steps consisting in:
compressing the soup powder, optionally containing technical additives, with a constant volume being held for a time that is sufficient for the holding force to diminish by at least 10% so as to obtain a solid unit;
moistening the solid unit;
drying the solid unit in such a manner as to obtain a compact; then
putting the compact into contact with at least one morsel.

The step of putting the compact into contact with the morsel(s) is performed by means of a binder. The purpose of using a binder is to create bonds between the compact and the morsel(s). The bonds may be solid bridges or chemical bonds. By way of example, mention may be made of the following binders: water; aqueous solutions based on sugars such as saccharose, glucose (in particular dextrose), fructose, lactose, sorbitol, mannitol; starch; polysaccharides; gums of the guar gum, xanthan gum, or gum Arabic type; agar agar; melted sugar; melted fat compositions; and hydrocolloids.

In a first embodiment the binder is applied to the compact. This step may be performed by spraying the binder on the compact, by depositing the binder on the compact, or by dipping the compact in a bath of binder.

In an alternative embodiment, the binder is applied to the morsels.

Once the binder has been applied, it is necessary to consolidate the bonds that have been created. This step may be performed by drying (for aqueous binders) or by cooling. By way of example, it is possible to cool a compact of the invention by passing it through cold air or a helium tunnel.

The invention can be better understood on reading the following description given merely by way of example, and with reference to the drawings, in which:

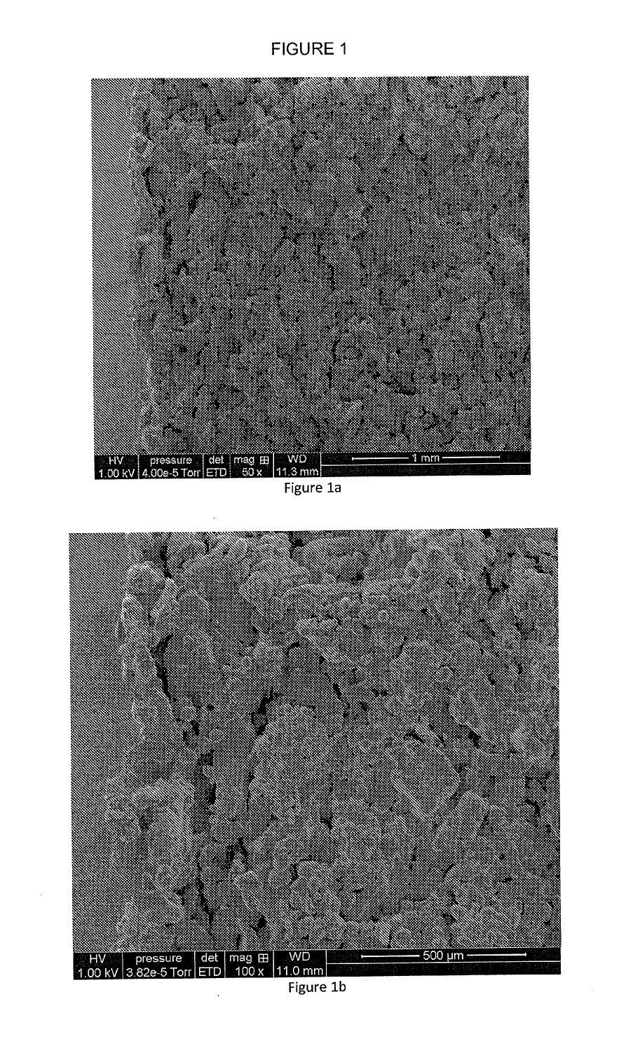

FIG. 1 shows two images obtained by scanning electron microscopy of a section of a soup powder compact of the invention, (×50, FIG. 1a; ×100, FIG. 1b); and

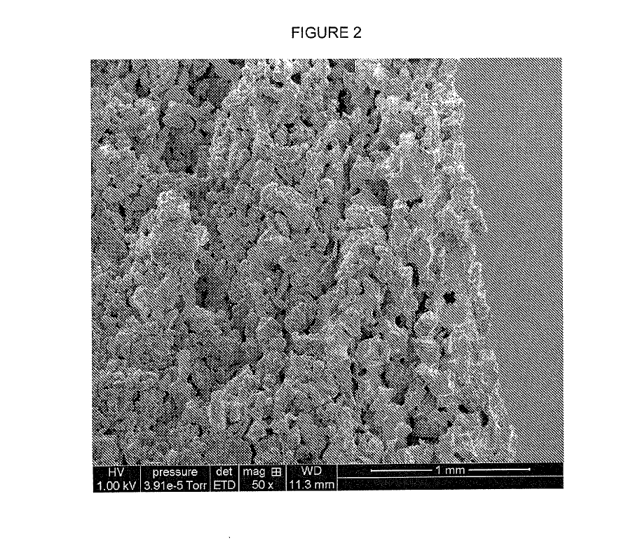

FIG. 2 shows an image obtained by scanning electron microscopy (×50) of a section of a soup powder compact of patent application JP 2004 049221.

### EXAMPLE 1

### Soup Compacts of the Invention

Four types of powdered soup were obtained on the market. Their compositions are given in the following table:

| | | | | Soups |
|---|---|---|---|---|
| | | | | for |
| | Instant soups | | | cooking |
| Composition | soup A | soup B | soup C | soup D |
| salt (%) | 7.1 | 8.3 | <10 | 7.1 |
| lipids (%) | 6.8 | 8.3 | 9.4 | 3.6 |
| carbohydrates (%) | 64.4 | 76.7 | 50 | 63.3 |
| vegetables (%) | 55 | 34 | 79 | 63 |

The four powdered soups were shaped in accordance with the general method described below, with a view to obtaining 8 g compacts of cylindrical shape having a diameter of 32 mm.
Optionally adding pelletizing or fiber additives to the soup powder;
compressing at constant volume;
spraying water; and
IR drying.

The specific characteristics of each method are given in the table below together with the characteristics of the compacts obtained.

| Composition | soup A | soup B | soup C | soup C | soup D | soup D | soup D |
|---|---|---|---|---|---|---|---|
| Compression | 50 | 50 | 50 | 50 | 50 | 50 | 50 |
| speed (mm/s) | | | | | | | |
| Constant- | 3000 | 250 | 3000 | 3000 | 3000 | 3000 | 3000 |
| volume hold time | | | | | | | |
| Density of | 0.94 | 0.98 | 0.98 | 1 | 1 | 1 | 1 |
| the compact | | | | | | | |
| Additives | 10% | 10% | 10% | / | 10% | 10% | 10% |
| (% by weight | malto- | malto- | malto- | | sorbitol + | sorbitol + | sorbitol + |
| relative to | dextrin* + | dextrin* + | dextrin* + | | 10% carrot | 10% carrot | 10% carrot |
| the weight | 10% carrot | 10% carrot | 10% carrot | | fibers | fibers | fibers |
| of the compact) | fibers | fibers | fibers | | | | |
| Quantity of | 3 | 3 | 2.5 | 2.3 | 3.2 | 1.5 | 5.3 |
| water (mg/cm²) | | | | | | | |
| Diametral | 0.02 | 0.03 | 0.02 | 0.03 | 0.13 | 0.05 | 0.13 |
| strength (MPa) | | | | | | | |
| Friability (%) | 0.9 | 0.2 | 0.8 | 1.2 | 0 | 0.2 | 0 |
| Crumbling time (s) | 80 | 80 | 20 | 80 | 25 | 20 | 30 |

*Additives already present in the soup powder.

Diametral strength was obtained by measuring hardness with a Dr Schleuniger hardness tester, friability was measured by means of a friability tester of the SOTAX F2 type provided with a friability drum inclined at 10° in accordance with the protocol as described above.

Crumbling time corresponds to the time required for a compact to crumble completely in 80 milliliters (mL) of water under the following conditions:
for preparing instant soup, the compact was introduced into a beaker, and simmering water (80° C.) was added directly onto the compact. The compact was stirred manually until it had crumbled away completely.
for preparing soup to be simmered, the compact was introduced into water that had been brought to the boil (100° C.). The compact was stirred manually until it had crumbled away completely.

### EXAMPLE 2

### Influence of Constant-Volume Hold Time

Soup powders B and C were shaped in accordance with the method described in the above example, and with the features given in the table below. The state of the compact was then evaluated.

| | soup C | soup C | soup B | soup B | soup B |
|---|---|---|---|---|---|
| Compression | 50 | 50 | 50 | 50 | 180 |
| speed (mm/s) | | | | | |
| Constant- | 0 | 3000 | 0 | 250 | 250 |
| volume hold | | | | | |
| time | | | | | |
| Additives | 10% malto- | 10% malto- | 10% malto- | 10% malto- | 10% malto- |
| (% by weight | dextrin* + | dextrin* + | dextrin* + | dextrin* + | dextrin* + |
| relative to | 10% carrot | 10% carrot | 10% carrot | 10% carrot | 10% carrot |
| the weight of | fibers | fibers | fibers | fibers | fibers |
| the compact) | | | | | |
| Visual state | broken | correct | broken | correct | correct |
| of the | compact | | compact | | |
| compact after | | | | | |
| compression | | | | | |

*Additives already present in the soup powder.

Conclusion: it can be seen that it is essential to hold a constant volume for a certain length of time in order to obtain a compact presenting sufficient strength and cohesion for it to be handled.

### EXAMPLE 3

### Influence of the Crusting Step

Soup powders A and C were shaped in accordance with the method described in the above examples, and with the features given in the table below. Diametral strength, friability, and crumbling time were then measured in accordance with the methods described in Example 1.

| | soup A | soup A | soup C | soup C |
|---|---|---|---|---|
| Compression | 50 | 50 | 50 | 50 |
| speed (mm/s) | | | | |
| Constant- | 3000 | 3000 | 3000 | 3000 |
| volume | | | | |
| hold time | | | | |
| Density of the | 0.94 | 0.94 | 0.98 | 0.98 |
| compact | | | | |
| Additives | 10% malto- | 10% malto- | 10% malto- | 10% malto- |
| (% by weight | dextrin* + | dextrin* + | dextrin* + | dextrin* + |
| relative to the | 10% carrot | 10% carrot | 10% carrot | 10% carrot |
| weight of the | fibers | fibers | fibers | fibers |
| compact) | | | | |
| Visual state of | correct | correct | correct | correct |
| the compact | | | | |
| after | | | | |
| compression | | | | |
| Sprayed-water | 3 | 0 | 2.5 | 0 |
| quantity | | | | |
| (mg/cm2) | | | | |
| Diametral | 0.02 | Not | 0.02 | Not |
| strength (MPa) | | measurable | | measurable |
| Friability (%) | 0.9 | broken | 0.8 | broken |
| | | compact | | compact |
| Crumbling | 80 | 80 | 20 | 20 |
| time (s) | | | | |

“Not measurable” means that the hardness is less than the detection limit of the Dr Schleuniger hardness tester.
*Additives already present in the soup powder.

Conclusion: it can be seen that the crusting step is essential in order to obtain a compact presenting sufficient strength for it to be handled (not broken).

### EXAMPLE 4

### Comparative Example Between a Soup Compact of the Invention and a Product Obtained by the Method Described in Document JP 2004 049221

The purpose of the study was to compare the structural elements of the crust of the invention with the structural elements of a compacted pellet obtained by means of a molding compression method comprising a step of moistening under saturated atmosphere in water at 100% (steam) at high temperature (100° C.), and a drying step of 30 minutes performed by hot air at 75° C., as described in Example 1 of document JP 2004 049221.

A commercially-available soup powder was used having the composition given in the table below:

| | Soup E |
|---|---|
| Salt (%) | 8.3 |
| Lipids (%) | 7.3 |
| Carbohydrates (%) | 48 |
| Vegetables (%) | 32 |

The values are expressed in total % by weight of the composition.

15 g pellets having a diameter of 45 mm were prepared in accordance with step a) of the method of the invention by compressing the powder with a constant volume being held for a time that was sufficient for the holding force to diminish by at least 10% so as to obtain a solid unit.

Next, the successive moistening and drying steps (b and c) of the invention were applied to one group of pellets, then the moistening and drying steps under the conditions of the above-mentioned Japanese patent application were applied to another group of pellets.

| | Control | The | JP |
|---|---|---|---|
| | example | invention | application |
| | Soup E | Soup E | Soup E |
| Compression | 50 | 50 | 50 |
| speed (mm/s) | | | |
| Constant- | 550 | 550 | 550 |
| volume hold | | | |
| time | | | |
| Density of the | 0.95 | 0.95 | 0.95 |
| compact | | | |
| (g/cm³) | | | |
| Additives | 5% carrot | 5% carrot | 5% carrot |
| (% by weight | fibers | fibers | fibers |
| relative to | | | |
| the weight of | | | |
| the compact) | | | |
| Visual state | correct | correct | correct |
| of the compact | | | |
| after | | | |
| compression | | | |
| Moistening | / | Water | Vapor |
| conditions | | spraying | condensation |
| | | | for |
| | | | 20 s/face |
| Water quantity | / | 4.5 | 14 |
| (mg/cm²) | | | |
| Drying | / | IR for | Hot air |
| conditions | | 20 s | 30 min, 75° C. |
| Diametral | Not | 0.026 | 0.07 |
| strength (MPa) | measurable | | |
| Dissolution in | 35 | 35 | 80 |
| 150 mL | | | |

For each group of pellets, the structure of the crust was analyzed by scanning electron microscopy (SEM).

For the group of pellets that were subjected to the method of the invention, a surface crust was observed having thickness that could be measured (see FIG. 1a). It was observed that its thickness varied in the range 35 μm to 220 μm (marked in FIG. 1 by the arrows) and was centered on the range 130 μm to 180 μm. It was observed that the crust/core interface was well defined by a sudden change in porosity and density. In order to see the crust more clearly, FIG. 1b is a larger-scale view of FIG. 1a.

For the group of pellets that were subjected to the method of the Japanese application, a surface crust was not observed, but a zone presenting a density gradient (see FIG. 2). In particular, there was no clearly defined interface.

### EXAMPLE 5

### Preparing a Pasta-Coated Soup Compact

An instant soup powder of grain size centered on 250 μm (Soup E) was used. The soup powder was compacted, then moistened by spraying water and dried by IR so as to obtain a compact presenting a dissolving time that was less than 1 min (Example 4 of the invention). Small pieces of pasta of size not less than 5 mm for application to the surface were wetted by soaking in water and were deposited by gravity on the compact. The pasta-coated compact was then dried by hot air at 100° C. for 10 min.

The compact obtained in this way was a soup compact coated in small pieces of pasta.

1-16. (canceled)

17. A soup compact containing 70% to 100% by weight of a soup powder and 0 to 30% by weight of technical additive(s), said compact being in the form of a solid unit of homogeneous composition that presents a crust of thickness lying in the range 10 μm to 1 mm.

18. A soup compact according to claim 17, wherein the soup powder has a salt content that is not greater than 20% by weight relative to the weight of the soup powder.

19. A soup compact according to claim 17, wherein the technical additive is sorbitol, and a dietary fiber supplement may be added to the soup powder.

20. A soup compact according to claim 17, wherein the compact has a density lying in the range 0.7 g/cm³ to 1.5 g/cm³ and/or a diametral strength lying in the range 0.01 MPa to 0.4 MPa and/or a crumbling time in water at 80° C. not greater than 2 min and/or a friability not greater than 10%.

21. A soup compact according to claim 17, presenting at least one morsel on the surface.

22. A soup compact according to claim 21, including a plurality of morsels that are distributed on its surface.

23. A soup compact according to claim 22, wherein the distribution of the morsels covers the surface completely or in part.

24. A soup compact according to claim 21, wherein the size of the morsels lies in the range 800 μm to 1 cm.

25. A method of manufacturing a soup compact, said method comprising the steps consisting in:
a) compressing the soup powder, optionally containing pelletizing additives, while holding a constant volume for time that is sufficient for the holding force to diminish by at least 10% so as to obtain a solid unit;
b) moistening the solid unit; then
c) drying the solid unit.

26. A method according to claim 25, wherein the time the constant volume is held lies in the range 0.1 s to 5 s.

27. A method according to claim 25, wherein the quantity of water added during the moistening step lies in the range 0.2 mg/cm² to 10 mg/cm².

28. A method according to claim 25, wherein the drying step makes it possible to re-establish the initial moisture content of the solid unit with an accuracy of plus or minus 1%.

29. A method according to claim 25, wherein the moistening step is performed by spraying, and the drying step is performed by infra-red.

30. A method of manufacturing a soup compact according to claim 25, the method including an additional step consisting in:
d) putting the compact into contact with the morsel.

31. A method of manufacturing a soup compact according to claim 30, wherein contact is performed by means of a binder.

32. A soup compact that may be obtained by the method according to claim 25.
